(19) United States
(12) Patent Application Publication
(10) Pub. No.: US 2016/0348371 A1
(43) Pub. Date: Dec. 1, 2016

(54) PROFILE SYSTEM FOR FIXING COVERINGS, IN PARTICULAR ROOF SEALING SHEETS

(71) Applicant: SIKA TECHNOLOGY AG, Baar (CH)

(72) Inventors: Roland STULIER, Landau (DE); Armin NÄF, Rothenburg (CH); Felix WEISS, Wilen/Gottshaus (CH); Robert BUFF, Romanshorn (CH)

(73) Assignee: SIKA TECHNOLOGY AG, Baar (CH)

(21) Appl. No.: 15/167,553

(22) Filed: May 27, 2016

(30) Foreign Application Priority Data
May 27, 2015 (EP) 15169381.9

(51) Int. Cl. E04D 3/38; E04D 3/36; E04D 3/34; F16B 7/04; E04D 3/18

(52) U.S. Cl. CPC E04D 3/38; F16B 7/0413; E04D 3/18; E04D 3/34; E04D 3/3602

(57) ABSTRACT

A profile system for fixing coverings, in particular roof sealing sheets, including at least one first fixing profile, at least one second fixing profile, wherein the first and the second fixing profiles each have a fixing flange, a first end section and a second end section, as well as at least one connecting clip for the detent reception of both the first end section of the first fixing profile and also the detent reception of the second end section of the second fixing profile in such a way that the first and the second fixing profiles form a common composite profile.

### TECHNICAL FIELD

The invention relates to a profile system for fixing coverings, in particular roof sealing sheets, to a roof sealing system as well as to a method for fixing coverings, in particularly roof sealing sheets, by using a profile system.

### PRIOR ART

Steel rails (profiles) are known in the prior art for the mechanical fixing of flat roof seals. Profiles of this kind normally have a (comparatively long) length of 4-5 m, in order to reduce the assembly costs on site. If several profiles have to be arranged axially one behind the other, then normally so-called “butt-joint flaps” are used in order to prevent the end edges of the profiles from damaging the covering of the profiles.

On the one hand it is thus possible to reduce the assembly costs on site using the longest possible profiles. On the other hand it has been shown that comparatively long profiles are linked with high logistic costs. It is then to be ascertained that often lengths of more than 2.40 m are considered as long goods. These long goods can no longer be shipped as standard goods and are therefore often delivered as “direct loads”. This means for the haulier that he has to transport loads which are difficult to combine and the loading space can therefore not be fully utilized. Furthermore in the case of comparatively long profiles there is the relatively high risk that they become damaged (by way of example bent) during transport.

Against this background the object of the invention is to propose a profile system which can be transported as easily as possible and which for the fitter is nevertheless linked with the lowest possible additional expenses during assembly. Furthermore a corresponding roof sealing system is to be proposed as well as a corresponding method for fixing coverings, in particular roof sealing sheets.

### DISCLOSURE OF THE INVENTION

This is achieved in particular by a profile system according to claim 1, a use of a profile system according to claim 13, a use of a connecting clip according to claim 14, a roof sealing system according to claim 15 as well as a method for fixing covers according to claim 16.

In particular this is achieved by a profile system for fixing coverings, in particular roof sealing sheets, comprising at least one first fixing profile, at least one second fixing profile, wherein the first and the second fixing profiles each comprise a fixing flange, a first end section and a second end section, as well as at least one connecting clip for the detent reception of both the first end section of the first fixing profile and also the detent reception of the second end section of the second fixing profile in such a way that the first and the second fixing profiles make up a common composite profile.

A basic concept of the invention lies in providing a connecting clip in which the fixing profiles can be received (with detent engagement). Comparatively short fixing profiles can thereby be used which can be connected to one another (on site) in a rapid uncomplicated manner by the connecting clip so that there is hardly any extra expense or effort required.

Overall, considerable costs can be saved (in particular during transport). It is possible to hold only one rail length (profile length) in the product range. Furthermore customer complaints regarding “too short” rails are hardly to be expected. The connecting clip serves at least in some sections also as a protection element and can also serve as a spacer. By way of example the connecting clip can serve as an edge protection. Furthermore as a result of the connecting clip any expensive cutting and welding of “butt-joint flaps” is no longer required. The connecting clip can also make assembly easier in sloping components (wall, light strips etc.). The connecting clip facilitates the assembly of the fixing profiles since the alignment of these can be undertaken rapidly and easily. As a whole thus not only are costs reduced, (in particular during transport), but also the laying and finishing of the profile system is improved (simplified). Connecting the profile systems can be carried out rapidly and easily by engaging (clicking in) the connecting clip. The alignment and assembly of the fixing profiles can be undertaken rapidly and easily by only one person.

A central concept of the invention is the connecting clip which is also per se the subject of the invention (without necessarily a system with corresponding fastening profiles having to be provided). Preferred configurations of the connecting clip can be drawn from the following.

The object of the invention is further achieved by using the profile system for fixing coverings, in particular the roof sealing sheets.

The object is further achieved by using a connecting clip for the detent reception of both a first end section of a first fixing profile and also the detent reception of a second end section of a second fixing profile in such a way that the first and the second fixing profiles form a common composite profile for fixing coverings, in particular roof sealing sheets.

The above object is furthermore achieved by a roof sealing system, comprising the profile system as well as a sub-structure and/or a damp and/or air barrier sheet and/or a heat-insulating layer and/or a sealing sheet and/or an in particular sealing profile cover.

Furthermore the object is achieved by a method for fixing coverings, in particular roof sealing sheets by using the profile system, wherein at least one end section is snap-fitted and/or pushed into the connecting clip. A snap-fit connection is preferably first carried out with a subsequent push-in connection.

By “detent reception” is meant in particular a form-fitting connection which can be formed between the connecting clip and the associated end section of the corresponding fixing profile. This connection preferably takes place in the form of a click connection, thus in particular a connection in which a connecting structure is elastically deformed (during connection) and then as a result of an elastic resetting force locks (holds with detent engagement) the elements which are to be connected. The fixing profiles serve for fixing coverings, in particular roof sealing sheets. By an “end section” is preferably to be meant a section of the corresponding fixing profile which extends from one end edge (the side end edge) of the profile up to 10% in the direction of the other end edge (side end edge). A “composite profile ” is a profile which comprises at least two (where applicable also three, four or more) fixing profiles which are demarcated structurally from one another (and can be connected by a connecting clip).

The first and/or second fixing profile can be made (at least in some sections) from metal (in particular steel). (Hot-dipped) refined steel is particularly preferred here. Alternatively the formation from another metal or from another metal alloy such as by way of example aluminium (aluminium alloy) is also possible. Formation from plastics is also conceivable. The covering can be fixed particularly securely with a design made from metal (or a comparatively dimensionally stable resistant plastics).

The fixing clip can be made (at least in some sections) from plastics, in particular an injection moulded (part). A design structure based on polyamide is particularly preferred. A proportion of polyamide can then amount to at least 30%, preferably at least 70%. It is alternatively also possible to form the fixing clip from metal (metal alloy). Manufacture from plastics is comparatively simple from the manufacturing technology viewpoint, and a detent connection can furthermore be produced in a simple manner.

The first and/or second fixing profile can be formed as a U-profile. Two web regions can be provided next to the fixing flange. The web regions are preferably forked and/or bent in at least some sections. An outwardly directed corner projection can be formed between the fixing flange and at least one web region. At least one web region can be curved inwards (at least in some sections). A transverse extension of the fixing flange can be at least 1.5 times, preferably at least 2.0 times, further preferably at least 2.5 times as large as an extension of the web regions in a direction which is perpendicular to a plane defined by the fixing flange. The U-profile is thus preferably a comparatively flat U-profile so that the fixing of the covering becomes particularly effectively possible and at the same time it is easier to seal the profile by a sealing cover. Folds and/or bends in the web region can then interact with the connecting clip in a synergistic manner so that a secure detent connection becomes possible between the respective fixing profile and connecting clip (or between the mutually adjoining fixing profiles). If a corner projection is provided the fixing flange is slightly raised relative to the sub-structure when placing the fixing profile. In an alternative design only the corner projection (or both corner projections) can be in contact with the sub-structure. The fixing of the covering (roof sealing sheet) is also thereby improved.

The respective end sections and the fixing clip are preferably configured to correspond with one another in such a way that a snap-fit connection can be produced. Alternatively or additionally a push-in connection can also be possible. A combined snap-fit/push-in connection is particularly preferred, in particular in such a way that the respective end section first enters into a snap-fit connection with the connecting clip and then is moved into its final assembly position when pushed in (e.g. moved in the axial direction). In general no further connecting elements are required (or provided) for connecting the connecting clip and the respective end sections. Connecting elements of this kind can be provided in addition where required.

The connecting clip and/or first and/or second fixing profile are (each) made preferably in one piece (monolithic), where required from a homogeneous material.

The first and/or second fixing profile can have at least one recess (hole). A recess of this kind preferably has the purpose of receiving corresponding fixing screws, in order to fix the fixing profile on the sub-structure. A plurality of such recesses (holes) are preferably provided, by way of example at least three or at least five recesses which where applicable can be arranged at regular spacing from one another (by way of example in the axial direction). The connecting clip can also have one or several recesses (holes).

Either fixing the connecting clip on the sub-structure or an additional fixing with the associated fixing profiles can be carried out via such recesses (holes). Thus the assembly expense overall is clearly reduced.

The fixing clip can have a U-shaped cross-section. A configuration of this kind enables in a structurally simple manner a detent reception of the associated end sections of the fixing profiles.

In a concrete embodiment the fixing clip has a stop against which at least one end edge of an associated end section can be placed. A clearly defined positioning of the end section on (in) the connecting clip is thereby possible which reduces the assembly costs. The stop element can preferably be configured and arranged so that the end edges of the two associated fixing profiles can be placed against surfaces of the stop element which are directed away from one another (in particular in such a way that the stop element functions as a spacer member).

In a preferred embodiment the connecting clip is configured (at least substantially) in plate-shaped formation. Alternatively or additionally the connecting clip can have on the longitudinal edges mountings (by way of example channel-like mountings) for at least sections of the fixing profiles (in particular the web regions thereof). In one concrete embodiment a region between the mountings of the longitudinal edges is (completely) flat. A connecting clip of this kind can overall be easily manufactured and is nevertheless comparatively reliable.

In an alternative embodiment the connecting clip has at least one ring section. At least one of the corresponding end sections of the fixing profiles can be inserted into this ring section. At least sections of the fixing profiles are completely enclosed by the connecting clip through a ring section of this kind, which reduces the risk that the fixing profiles may damage the roof sealing sheet (covering).

The connecting clip can be configured in such a way that it (in the assembled state) covers at least sections of an upper side of at least one fixing profile, in particular at least sections of an inner face of the fixing flange. Alternatively or additionally the connecting clip can be configured so that it (in the assembled state) covers at least sections of the web regions. Alternatively or additionally the connecting clip can be configured so that it covers at least sections of an underneath side of at least one fixing profile, in particular an outer face of the fixing flange. The connecting clip in a particularly preferred manner covers at least in part the end edges (side end edges) of the fixing profiles so that the risk of damage (or injury) through these end edges is reduced.

The fixing profiles can be shorter than 3.5 m, preferably shorter than 2.5 m. Furthermore the fixing profiles are comparatively longer than 1.0 m, furthermore preferably longer than 1.5 m.

In a concrete embodiment an end clip is provided for the detent reception of the second end section of the first profile element. Further end clips (in particular for receiving the first end section of the second profile element) can likewise be provided. An end clip of this kind is preferably configured as a “cap” which can be clipped onto the respective end section. A push-on fit is likewise possible (as an alternative or in addition). The risk of damage or injury can be further reduced through an end clip of this kind.

One surface of the connecting clip which comes into contact with the associated fixing profile can have at least one projection (by way of example one or at least two ribs). When the fixing profile comes into contact with the connecting clip these projections can yield (slightly). Manufacturing tolerances can thereby be compensated in a simple manner.

### DESCRIPTION OF THE DRAWINGS

Advantages and the suitability of the invention are apparent from the following description of preferred exemplary embodiments with reference to the drawings. In the drawings:

FIG. 1 shows a diagrammatic inclined view of a first embodiment of the profile system;

FIG. 2 shows a front view of a fixing profile of the profile system according to FIG. 1;

FIG. 3 shows a second inclined view of the profile system according to FIG. 1;

FIG. 4 shows a connecting clip of the fixing system according to FIG. 1 in an inclined view;

FIG. 5 shows a diagrammatic inclined view of a second embodiment of a profile system;

FIG. 6 shows an inclined view of the connecting clip according to the embodiment according to FIG. 5 in a first inclined view;

FIG. 7 shows the connecting clip according to FIG. 6 in a second inclined view;

FIG. 8 shows the connecting clip according to FIGS. 6 and 7 in a view from above;

FIG. 9 shows the connecting clip in section along the line IX-IX;

FIG. 10 shows the connecting clip according to FIG. 8 in a view from the front;

FIG. 11 shows the connecting clip according to FIG. 10 including the fixing profile received therein in a view from the front;

FIG. 12 shows a roof structure in a diagrammatic illustration.

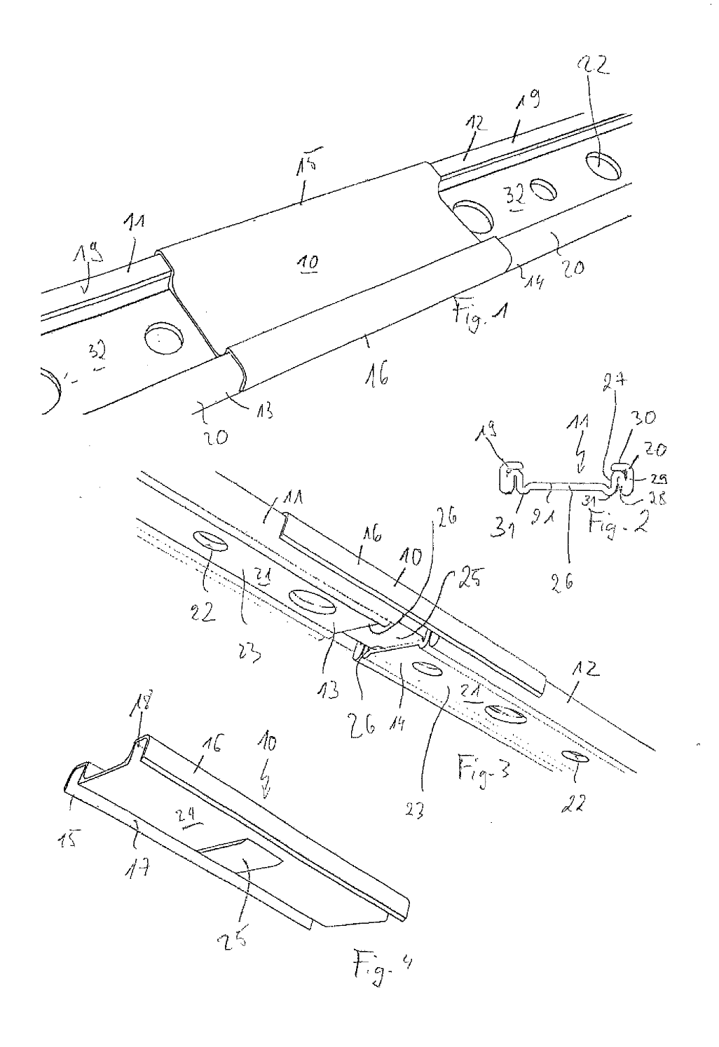

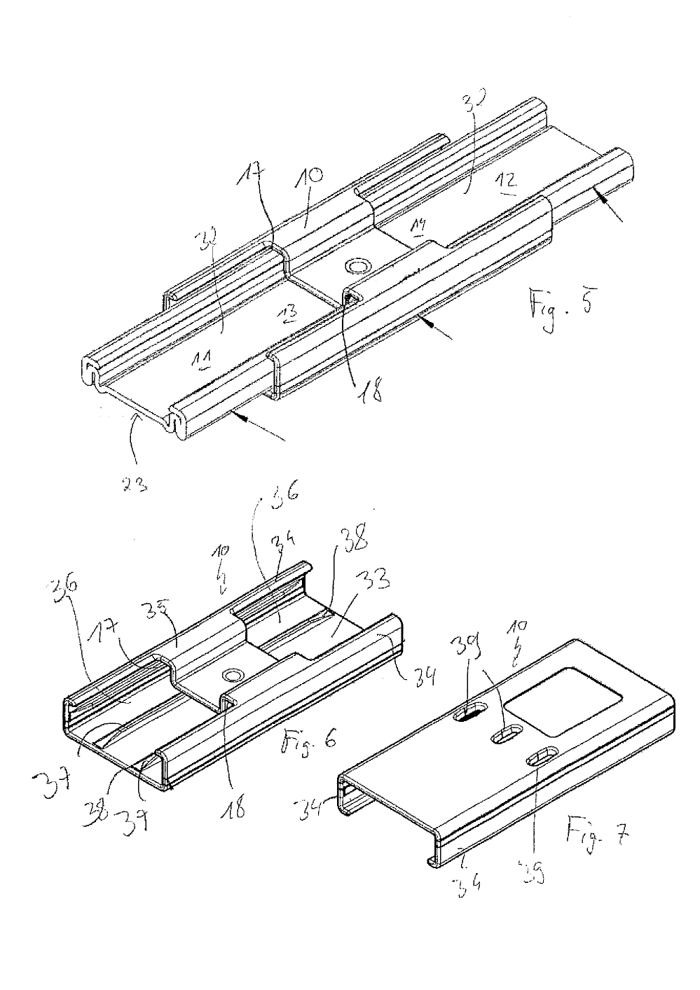

FIG. 1 shows a first embodiment of the profile system in an inclined view from above. FIG. 3 shows the profile system according to FIG. 1 in an inclined view from below. A connecting clip 10 is shown in an inclined view from below in FIG. 4 (without the fixing profiles 11 and 12 which are shown in FIGS. 1 and 3). As an example for the fixing profiles 11, 12 the fixing profile 11 is shown in FIG. 2 in a view from the front. The fixing profiles 11, 12 each have a first and a second end section. FIGS. 1 and 3 show the first end section 13 of the first fixing profile 11, and furthermore the second end section 14 of the fixing profile 12. The fixing profiles 11, 12 and the connecting clip 10 form a composite profile (as can be seen in FIGS. 1 and 3).

For this the connecting clip 10 is clipped onto the fixing profiles 11, 12, or their end sections 13, 14 respectively. Furthermore the connecting clip 10 has on its longitudinal edges 15, 16 (channel-like) mountings 17, 18 (see FIG. 4) in which web regions 19, 20 of the fixing profiles 11, 12 are received with detent engagement.

As a whole (see FIG. 2) the fixing profiles are configured U-shape and have a fixing flange 21 next to the web regions 19, 20. These fixing flanges (see FIGS. 1 and 3) have holes 22 in which screws (or other fixing means) can be inserted in order to fix the fixing profiles (or the composite profile) on a sub-structure (e.g. roof sealing sheet). The underneath 23 of the fixing profiles shown in FIG. 3 is then oriented towards the sub-structure.

The connecting clip 10 is configured flat (or at least substantially flat) between the mountings 17, 18 (see FIG. 4), but has on its underneath side 24 a stop element (in particular a flat projection) 25 (see also FIG. 3), which enables positioning or placing of the end edges 26 of the fixing profiles 10, 11. The stop element 25 can have in the axial direction preferably an extension of more than 0.5 cm and/or less than 2 cm, by way of example 1.0 cm.

The connecting clip 10 is made from polyamide (or another plastics), preferably PA6. By way of example manufacture can be carried out using the injection moulding method. The material is preferably selected so that the connecting clip 10 has sufficient elasticity for detent connection with the fixing profiles 11, 12.

The web regions 19, 20 of the fixing profiles 11, 12 (see FIG. 2) have a first section 27 projecting up from the fixing flange 21, an adjoining second section 28 running in the direction of the fixing flange 21, a third section 29 running away from the fixing flange 21, as well as a fourth section 30 running inwards (approximately) parallel to the fixing flange 21. As a whole the web region is thus bent or folded (several times). A projection 31 runs between each fixing flange 21 and the web regions 19, 20 so that the fixing profiles lie on the projections 31 when placed on a sub-structure (and/or where required on an apex point between the sections 28, 29). As a result of the structure of the web regions illustrated in FIG. 2 these web regions can be brought particularly effectively into engagement with the mountings 17, 18 of the connecting clip 10.

FIG. 5 shows an inclined view of a second embodiment of the profile system. The fixing profiles 11, 12 correspond here to the fixing profiles of the embodiment according to FIG. 1. The connecting clip 10 is however configured differently from this.

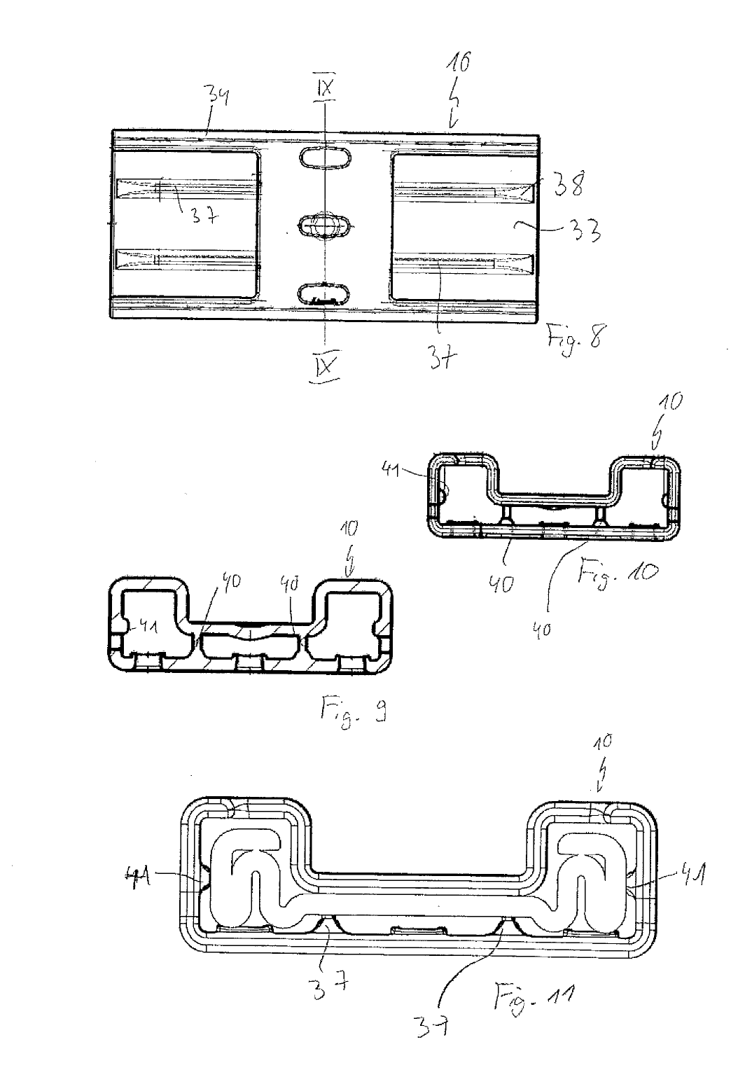

In the embodiment according to FIG. 1 the connecting clip 10 covers (only) sections of an upper side 32 of the fixing profiles. In the embodiment according to FIG. 5 the connecting clip 10 covers in addition to sections of the upper side 32 also sections of the underneath side 23 of the fixing profiles 11, 12. According to FIGS. 6 and 7 the connecting clip 10 of the embodiment according to FIG. 5 has a base 33 on whose longitudinal edges there are webs 34 which in turn are bridged by a bridging element 35 (in a central region) so that a closed ring is formed in the region of the bridging element 35. The bridging region 35 together with the sections of the webs 34 adjoining same can correspond in cross section to the connecting clip 10 of the embodiment according to FIG. 1. Analogous to the connecting clip 10 the bridging section 35 thus also has together with the adjoining webs 34 mountings 17, 18 in which the web regions 19, 20 of the fixing profiles 11, 12 can be housed. As a result of the base 33 the final positioning of the fixing profiles on the connecting clip 10 according to FIGS. 5 to 7 is carried out by pushing (inserting) them into the mountings 17, 18. For this the respective fixing profile 11, 12 is first clipped into openings 36, which are defined by the base 33 and the webs 34 adjoining the base (apart from the region of the bridging element 35), and is then pushed in the direction of a centre of the bridging element 35. Ribs 37 with tapering inclines 38 enable manufacturing tolerances of the fixing profiles 11, 12 to be compensated. In concrete form the ribs 37 yield (slightly), when a fixing profile (at least “oversized” in dimensions) is inserted and brought into its end position.

Recesses 39 running perpendicular to the axial direction (see FIG. 7) (the recesses can also run in another direction, thus also more or fewer than three recesses, by way of example only one recess can be present) enable the connecting clip to be fixed on the sub-structure.

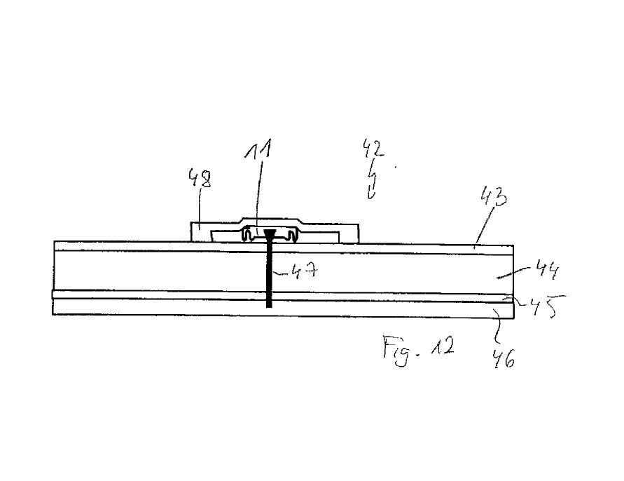

FIGS. 8 to 11 show further details of the connecting clip 10 according to the embodiment according to FIGS. 5 to 7. Stop elements 40 can be concluded from the section according to FIG. 9 (along the line IX-IX in FIG. 8) which enable a defined positioning of the fixing profiles 11,12. At the same time the stop elements 40 space the mutually adjoining fixing profiles 11, 12 apart from one another.

Furthermore further ribs 41 can be seen from FIGS. 9 to 11 which enable (like the ribs 37) compensation of the manufacturing tolerances.

FIG. 12 shows a roof structure 42. This roof structure 42 comprises a roof sealing sheet 43 which is applied to a heat-insulating layer 44. The heat- insulting layer 44 in turn lies above a damp/air proof sheet 45. The sheet 45 is arranged on a sub-structure 46 (by way of example a steel trapeze profile, a wooden structure and/or steel or porous concrete). The heat-insulating layer 44 can comprise for example mineral wool and/or hard foam (e.g. EPS). The roof sealing sheet 43 is fixed by means of the fixing profile 11 and a fixing screw 47 on the elements which are arranged underneath the roof sealing sheet 43. In order also to enable a seal in the region of the fixing profile 11 as well as the screw 47 a sealing strip 48 (running perpendicular to the plane of the drawing) is arranged above the fixing profile 11.

The base 33 in the embodiment according to FIG. 5 reduces the risk that the fixing profiles may damage the roof sealing sheet lying underneath same. On the other hand it is also to be ascertained that in this region (when screw connections are provided analogous with FIG. 12) injuries or through holes in the roof sealing sheet 43 may readily exist. As a result the embodiment according to FIG. 1 is particularly preferred since the structural expense for the corresponding connecting clip 10 is comparatively basic and the assembly of the connecting clip 10 can also be easily undertaken. Should damage to the roof sealing sheet occur in this region as a result of the lack of covering of the underneath side 23 of the fixing profiles 11, 12, then this would be acceptable where necessary since through-bores in the roof sealing sheet are introduced anyhow (as a result of screws which are inserted into the holes 22).

The fixing profiles 11, 12 have for example a length of 2.25 m, but can also be made longer or shorter. The connecting clip 10 can have a length of more than 5 cm. Furthermore the connecting clip can have a length of less than 20 cm (preferably less than 15 cm). A width of the fixing profiles is preferably at least 3 cm, furthermore preferably at least 5 cm and/or at most 10 cm, preferably at most 8 cm.

### LIST OF REFERENCE NUMERALS

10 Connecting clip

11 First fixing profile

12 Second fixing profile

13 First end section of the first fixing profile

14 Second end section of the second fixing profile

15 Longitudinal edge

16 Longitudinal edge

17 Mounting

18 Mounting

19 Web region

20 Web region

21 Fixing flange

22 Hole

23 Underneath side of 11, 12

24 Underneath side of 10

25 Stop element

26 End edge

27 Section

28 Section

29 Section

30 Section

31 Projection

32 Upper side

33 Base

34 Web

25 Bridging element

36 Opening

37 Rib

38 Tapering incline

39 Recess

40 Stop element

41 Rib

42 Roof structure

43 Roof sealing sheet

44 Heat-insulating layer

45 Damp/air proof sheet

46 Sub-structure

47 Fixing screw

48 Sealing strip

1. Profile system for fixing coverings, comprising at least one first fixing profile, at least one profile, wherein the first and the second-fixing profiles each have a fixing flange, a first end section and a second end section as well as at least one connecting clip for the detent reception of both the first end section of the first fixing profile and also the detent reception of the second end section of the second fixing profile in such a way that the first and the second fixing profiles form a common composite profile.

2. Profile system according to claim 1, wherein the first and/or the second fixing profile is/are made at least in some sections from metal, and/or the fixing clip is made at least in some sections from plastics.

3. Profile system according to claim 1, wherein the first and/or the second fixing profile is formed as a U-profile and has two web regions, wherein the web regions are folded and/or bent at least in some sections and/or an outwardly directed corner projection is formed between the fixing flange and at least one web region, and/or wherein at least one web region is curved inwards at least in some sections and/or wherein a transverse extension of the fixing flange is at least 1.5 times.

4. Profile system according to claim 1, wherein the end sections and the connecting clip are formed to correspond with one another in such a way that a snap-fit connection and/or push-fit connection, can be produced, in such a way that the relevant end section first produces a snap-fit connection with the connecting clip and then is changed into its final assembly position by push-fit, and/or a connection can be produced without further connecting elements.

5. Profile system according to claim 1, wherein the first and/or the second fixing profile and/or the connecting clip has/have at least one recess.

6. Profile system according to claim 1, wherein that the connecting clip has a U-shaped cross-section.

7. Profile system according to claim 1, wherein the connecting clip has a stop element against which at least one end section can be placed, wherein the stop element is designed and arranged so that the end edges of the two fixing profiles can be placed against surfaces of the stop element which are directed away from one another, in such a way that the stop element functions as a spacer member.

8. Profile system according to claim 1, wherein the connecting clip is substantially plate-shape in design and/or has on the longitudinal edges mountings for mounting at least sections of the web regions.

9. Profile system according to claim 1, wherein the connecting clip has at least one ring section in which at least one end section can be inserted.

10. Profile system according to claim 1, wherein the connecting clip covers at least sections of an upper side of at least one fixing profile, at least sections of an inner face of the fixing flange and/or at least sections of the web regions, and/or covers at least sections of an underneath side of at least one fixing profile.

11. Profile system according to claim 1, wherein the fixing profiles are shorter than 3.5 m, and/or longer than 1.0 m.

12. Profile system according to claim 1, wherein an end clip is provided for the detent reception of the second end section of the first profile element.

13. Profile system according to claim 1 for fixing coverings.

14. A connecting clip for the detent reception both of a first end section of a first fixing profile and also for the detent reception of a second end section of a second fixing profile in such a way that the first and the second fixing profile form a common composite profile for fixing coverings.

15. Roof sealing system, comprising a profile system according to claim 1 as well as a sub-structure and/or a damp and/or air proofing sheet and/or a heat-insulating layer and/or a roof sealing sheet and/or an sealing profile covering.

16. Method for fixing coverings, by using a profile system according to claim 1, wherein at least one end section is snap-fitted and/or push-fitted into the connecting clip.
